(19) United States
(12) Patent Application Publication
(10) Pub. No.: US 2019/0346640 A1
(43) Pub. Date: Nov. 14, 2019

(54) OPTICAL MODULE

(71) Applicant: Hisense Broadband Multimedia Technologies Co., Ltd., Qingdao (CN)

(72) Inventors: Yifan Xie, Qingdao (CN); Qinhao Fu, Qingdao (CN); Yongzheng Tang, Qingdao (CN); Guangchao Du, Qingdao (CN)

(21) Appl. No.: 16/431,166

(22) Filed: Jun. 4, 2019

Related U.S. Application Data
(63) Continuation of application No. PCT/CN2019/086693, filed on May 13, 2019.

(30) Foreign Application Priority Data
May 14, 2018 (CN) 201810455917.9
Jun. 14, 2018 (CN) 201810615437.4

(51) Int. Cl. G02B 6/42

(52) U.S. Cl. CPC G02B 6/4246; G02B 6/4277; G02B 6/4281

(57) ABSTRACT

An optical module is provided. In some examples, the optical module includes an upper shell, a lower shell, a box and a circuit board, wherein the circuit board and the box are arranged within a chamber formed by the upper shell and the lower shell. The box is internally provided with one or more optical device. A first notch is provided on one of two opposite side walls of the box. The circuit board extends into the box through the first notch and is electrically connected to the optical device inside the box by wire bonding.

### CROSS-REFERENCE TO RELATED APPLICATIONS

This application is a continuation application of International Application No. PCT/CN2019/086693 filed on May 13, 2019, which claims priority to Chinese Patent Application No. 2018104559179 entitled “OPTICAL MODULE” filed on May 14, 2018 and Chinese Patent Application No. 2018106154374 entitled “OPTICAL MODULE” filed on Jun. 14, 2018, the entire contents of which are incorporated herein by reference.

### TECHNICAL FIELD

The present disclosure relates to communication technology, and in particular to an optical module.

### BACKGROUND

Active Optical Cables (AOC) are communication cables for photoelectric conversion by external energy during communication. Some AOC include an optical fiber and an optical module at both ends of the optical fiber. The optical fiber and the optical module are connected for photoelectric conversion.

An optical module is a component for photoelectric conversion in an AOC, wherein a transmitter converts an electrical signal into an optical signal and transmits the optical signal via the optical fiber. A receiver converts the received optical signal into the electrical signal. Some optical modules are packaged by a hermetic packaging method for sealing the optical module during actual use. In some instances, there are many types of components in the optical module.

### SUMMARY

An optical module according to at least one embodiment of the present disclosure includes an upper shell, a lower shell, a box and a circuit board. The box is arranged within a chamber defined by the upper shell and the lower shell and configured to receive an optical device. A first side wall of the box includes a first notch. The circuit board is arranged within the chamber formed by the upper shell and the lower shell. The circuit board extends into the box through the first notch, and is electrically connected to an optical device inside the box using a bonded wire.

One of ordinary skill in the art would understand that the above general descriptions and the below detailed descriptions are merely exemplary and explanatory, and are not intended to limit the scope of the present disclosure.

### BRIEF DESCRIPTION OF THE DRAWINGS

To describe the embodiments of the present disclosure more clearly, drawings for the examples of the present disclosure will be briefly introduced below. It is apparent that other drawings may be obtained by those of ordinary skill in the art based on these drawings without paying creative work.

FIG. 1 is a schematic diagram of a structure of an optical module according to some approaches.

FIG. 2 is an exploded schematic diagram of a structure of an optical module according to some embodiments of the present disclosure.

FIG. 3 is a schematic diagram of a structure when a first circuit board is connected with a box according to some embodiments of the present disclosure.

FIG. 4 is a schematic diagram of a structure when a second circuit board is connected with a box according to some embodiments of the present disclosure.

FIG. 5 is a schematic diagram of a structure of a box without an upper cover according to some embodiments of the present disclosure.

FIG. 6 is a schematic diagram of a structure of a circuit board according to some embodiments of the present disclosure.

FIG. 7 is an enlarged schematic diagram of a structure of a connection position of a circuit board and a box according to some embodiments of the present disclosure.

FIG. 8 is a schematic diagram of a structure following a wire bonding connection according to some embodiments of the present disclosure.

FIG. 9 is a schematic diagram of a structure of a box according to some embodiments of the present disclosure.

FIG. 10 is a top contour view of a circuit board and a box in an optical module structure according to some embodiments of the present disclosure.

FIG. 11 is a schematic diagram of a structure of an optical module according to some embodiments of the present disclosure.

FIG. 12 is a section view of the optical module according to some embodiments of the present disclosure.

FIG. 13 is a partial schematic diagram of the optical module according to some embodiments of the present disclosure.

FIG. 14 is a schematic diagram of a structure of an arrayed waveguide grating chip according to some embodiments of the present disclosure.

FIG. 15 is a partial schematic diagram of the optical module according to some embodiments of the present disclosure.

### DETAILED DESCRIPTION OF THE EMBODIMENTS

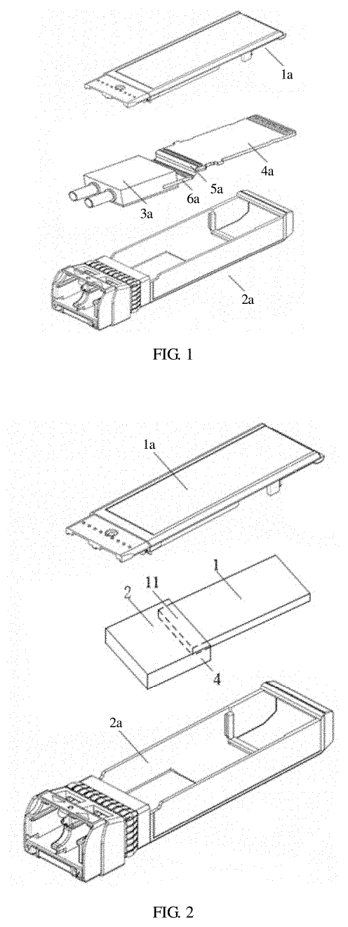

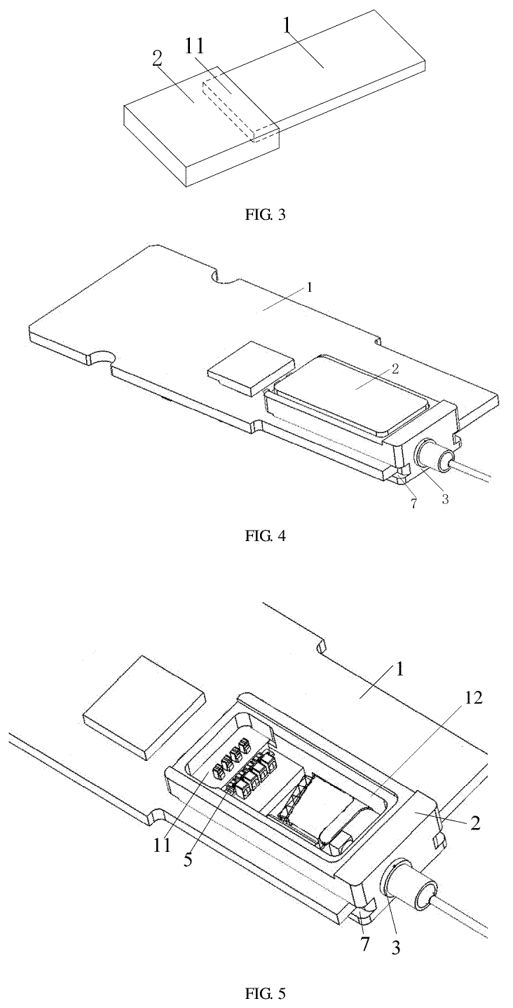

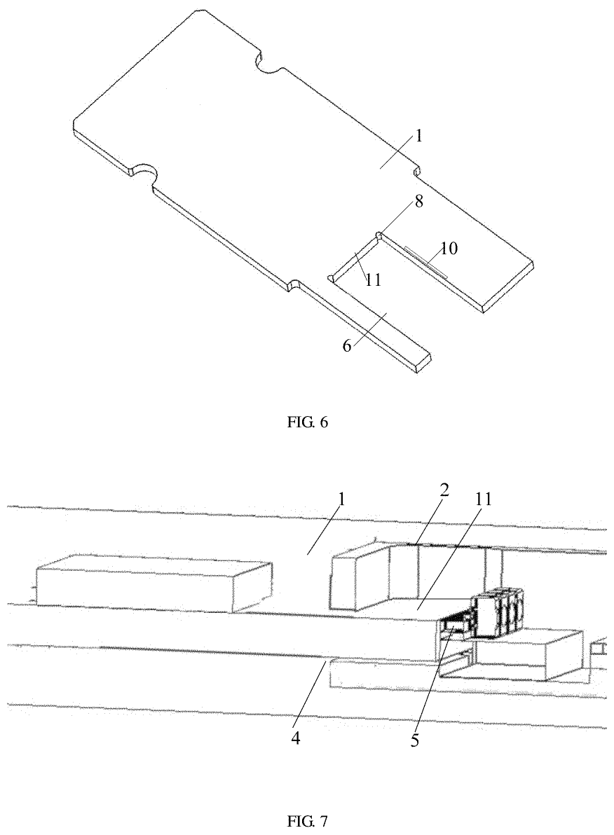

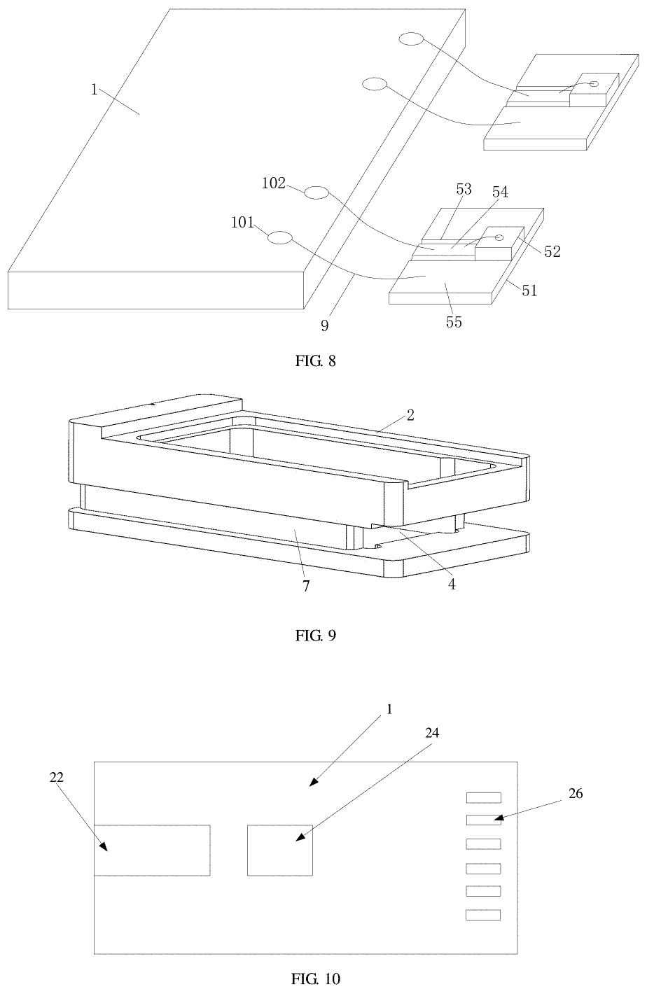

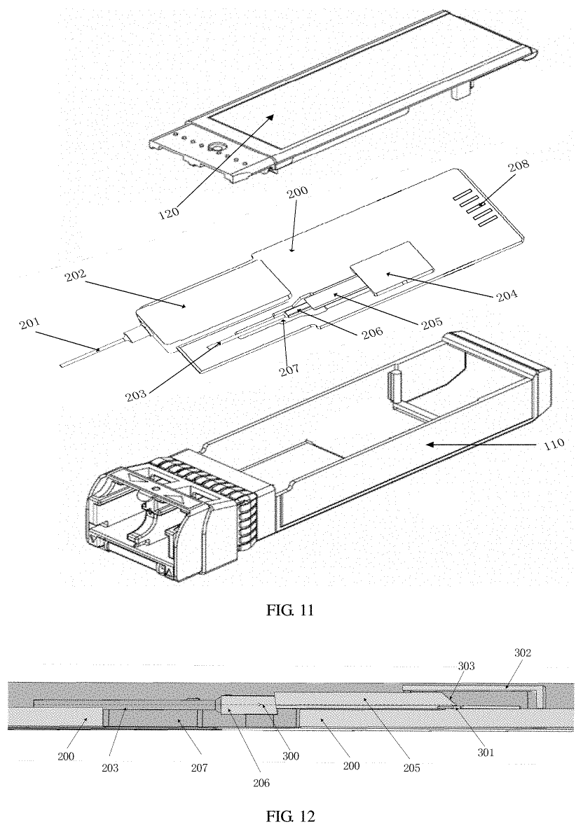

FIG. 1 is a schematic diagram of a structure of an optical module in some approaches. As shown in FIG. 1, the optical module includes an upper shell 1a, a lower shell 2a, a box 3a and a circuit board 4a, where an optical device is packaged in the box 3a. A closed chamber is formed by the upper shell 1a and the lower shell 2a, and the box 3a and the circuit board 4a are located within the closed chamber. An end of the circuit board 4a is connected to a flexible circuit board 5a, and a ceramic 6a having a metal wire is placed on the flexible circuit board 5a. Therefore, the circuit board 4a is connected to the box 3a through the flexible circuit board 5a, the ceramic 6a and the metal wire, therefore establishing a connection between the box 3a and the circuit board 4a.

Since the circuit board 4a is connected to the box 3a through the flexible circuit board 5a, the ceramic 6a and the metal wire, there are several types of components between the box 3a and the circuit board 4a. As a result, a distance between the box 3a and the circuit board 4a is increased, and the optical module is complicated in structure and more expensive to produce. Further, impedance continuity between the box 3a and the circuit board 4a is poor since a photoelectric signal may attenuate during transmission among the larger number of components. As a result, a photoelectric conversion efficiency of the optical module is reduced.

In contrast, an optical module according to some embodiments of the current description includes an upper shell, a lower shell, and a circuit board and a box which are located within a chamber formed by the upper shell and the lower shell. A through-hole and a notch (i.e., a first notch) are on opposite side walls of the box, respectively. The through-hole allows light pass through. An optical device is placed in the box. In some embodiments, the optical device includes one or more lens and a laser. The light emitted from the laser passes through the lens, and is then transmitted through the through-hole to outside of the box. The circuit board extends into the box through the notch on the side wall, and the portion of the circuit board which is extended into the box is electrically connected to the laser using bonded wires. Part of the circuit board extends into the box through the notch on the side wall, which greatly reduces the distance between the circuit board and the box in comparison with the arrangement in FIG. 1. As a result, the circuit board has close contact with the box. Further, the part of the circuit board extending into the box is electrically connected to the optical device using bonded wires. In this way, short-distance wire bonding between the circuit board and the box contributes to transmission of high-speed signals, and also is helpful for simplifying the structure between the circuit board and the box. The optical module is also less complex than the arrangement in FIG. 1. In addition, due to direct short-distance bonding connection between the box and circuit board, impedance matches well between the box and circuit board, thereby reducing the attenuation of the photoelectric signals.

An optical module according to some embodiments of the present disclosure is described in detail with specific examples in combination with accompanying drawings.

FIG. 2 is an exploded schematic diagram of a structure of an optical module according to some embodiments of the present disclosure. As shown in FIG. 2, an optical module includes an upper shell 1a, a lower shell 2a, a circuit board 1 and a box 2, where the circuit board 1a and the box 2 are placed within a chamber formed by the upper shell 1a and the lower shell 2a.

Specifically, the upper shell 1a is a hollow shell with an opening at a side surface. The lower shell 2a is a hollow shell with an opening at a side surface. The opening on the side surface of the upper shell 1a is opposite to the opening on the side surface of the lower shell 2a. When the side surface of the upper shell 1a with the opening and the side surface of the lower shell 2a with the opening are closed, a space between the two side surfaces forms a chamber for receiving components or apparatuses. The circuit board 1 and the box 2 are disposed within the chamber formed by the upper shell 1a and the lower shell 2a, to help protect the circuit board 1 and the box 2 with the upper shell 1a and the lower shell 2a.

In some embodiments, the circuit board 1 includes one or more welding pads, one or more via holes, one or more mounting holes, one or more wires, one or more components, connectors, or the like. In some embodiments, the circuit board 1 further includes support electronic elements in the optical module, acting as a carrier for different circuit chips, signal lines, or the like. Patterns on the circuit board 1 repeat and are consistent with each other, so that errors of wring and assembly are reduced, and time of maintenance, debugging or inspection of equipment is reduced. Furthermore, the circuit board 1 is configured to have a high wiring density, a small volume and a light weight. Therefore, the circuit board 1 is adapted to minimize the structure of electronic devices. In addition, the circuit board 1 also has favorable features such as high reliability, designability, productivity and assemblability.

The box 2 is a hollow box structure. In some embodiments, the box 2 is a cuboid or cubic structure. In some embodiments, a through-hole 3 and a notch 4 are arranged on opposite side walls of the box 2. Both the through-hole 3 and the notch 4 are in communication with the internal space of the box 2. The through-hole 3 is designed to allow an optical fiber interface and an optical fiber support to pass through, or the like. The notch 4 is designed to allow the circuit board 1 to pass through. In some embodiments, the box 2 is internally provided with a lens (not shown) and a laser 5. Light emitted from the laser 5 passes through the lens, and is transmitted through the through-hole to outside of the box 2. In this way, optical signals are able to be transmitted and received through an interaction between the circuit board 1 and different optical devices arranged inside the box 2, thereby achieving photoelectric conversion using the optical module.

In an optical module in some embodiments of the present disclosure, the circuit board 1 includes a wire bonding circuit board 11 and a first circuit board, where the first circuit board is a part of the circuit board 1 other than the wire bonding circuit board 11. When the circuit board 1 is connected with the box 2, a portion of the circuit board 1 extends into the box 2 through the notch 4. That is, the wire bonding circuit board 11 extends into the box 2 through the notch 4. A part of the circuit board 1 extends into the box 2 through the notch 4, making the distance between the circuit board 1 and the box 2 decrease. In some embodiments, the circuit board 1 directly contacts the box 2. The decreased distance or direct contact reduces a volume of the optical module. When extending into the box 2 through the notch 4, the wire bonding circuit board 11 is electrically connected to the laser 5 inside the box 2 using a bonded wire. Wire bonding is a wire connect method where the metal wire within a solid state circuit of a microelectronic device is connected by hot pressing or ultrasound energy. Since the circuit board 1 is in direct contact with the box 2, in some embodiments, short-distance wire bonding is utilized between the wire bonding circuit board 11 and the box 2. Short-distance wire bonding facilitates transmission of high-speed signals. Further, since the wire bonding circuit board 11 is directly and electrically connected to the laser 5 inside the box 2 by wire bonding, impedance matches well between the circuit board 1 and the interior of the box 2. As a result, attenuation of the photoelectric signals is reduced and the photoelectric conversion efficiency of the optical module is improved.

Specifically, FIG. 3 is a schematic diagram of a structure where a first circuit board is connected with a box according to some embodiments of the present disclosure. In FIG. 3, a width or an end width of the circuit board 1 is less than or equal to a width between two inner side walls of a box 2. In this case, the wire bonding circuit board 11 is an end of the circuit board 1. When the wire bonding circuit board 11 extends into the box 2 through the notch 4, an entire end of the circuit board 1 is inside the box 2. This arrangement results in near distance contact between the circuit board 1 and the box 2. The structure where the first circuit board 1 is connected with the box 2 in some embodiments of the present disclosure is applicable to a case where a width or an end width of the circuit board 1 is less than the width of the box 2.

FIG. 4 is a schematic diagram of a structure where a second circuit board is connected with a box according to some embodiments of the present disclosure. FIG. 5 is a schematic diagram of a structure of the box without an upper cover according to some embodiments of the present disclosure. In FIG. 4 and FIG. 5, the width of the circuit board 1 is greater than the width of the box 2. Here, the circuit board 1 cannot be inserted into the box 2. In some embodiments of the present disclosure, in a case that the width of the circuit board 1 is greater than the width of the box 2, a recess 6 (i.e., a second notch) is arranged on an end of the circuit board 1. In this scenario, a portion of the circuit board passes the recess 6 and extends into the box 2 is the wire bonding circuit board 11, as in FIG. 6. In some embodiments, when the recess 6 is provided on the end of the board circuit 1, the box 2 is arranged at the recess 6 and the wire bonding circuit board 11 is extended into the box 2 through the recess 6.

Similar to the structure where the circuit board 1 is connected with the box 2 in some embodiments of the present disclosure, when the box 2 is located at the recess 6 and the wire bonding circuit board 11 extends into the box 2 through the recess 6, distances between different electronic elements arranged on the circuit board 1 and different optical devices inside the box 2 are shortened. The structure where the circuit board 1 is connected with the box 2 in some embodiments of the present disclosure is applicable to a case where a width or an end width of the circuit board 1 is greater than the width of the box 2.

In structures where the circuit board 1 is connected with the box 2 according to the above embodiments, the circuit board is extends into the box 2 through the notch 4, so that the distance between the circuit board 1 and the interior of the box 2 is shortened. As a result, near distance contact exists between the circuit board 1 and the box 2. However, the structures where the circuit board 1 is connected with the box 2 according to the embodiments of the present disclosure are not intended to limit to the above described embodiments. In some embodiments, the circuit board 1 extends into the box 2 through the notch 4. For example, the box 2 is placed at a central position of the circuit board 1.

For the optical module in FIG. 1, the circuit board 4a is connected to the box 3a through the flexible circuit board 5a, the ceramic 6a and the metal wire. Therefore, the distance between the circuit board 4a and the box 3a is relatively far in comparison with FIGS. 2-5. As a result, many components are arranged between the circuit board 4a and the box 3a. In some instances, the optical module is located outdoors or at places with a lot of dust or high humidity during use. If pollutants such as dust or moisture enters between the circuit board 4a and the box 3a, the pollutants such as dust or water vapor enter the box 3a and pollute different optical devices inside the box 3a. As a result, the electrical signals transmitted between the circuit board 4a and the box 3a are attenuated which impacts data transmission. Therefore, in the optical module, the circuit board 4a, the flexible circuit board 5a, the ceramic 6a, the metal wire and the optical device box 3a are packaged based on a hermetic packaging technology, to help prevent the pollutants such as dust or moisture from entering between the circuit board 4a and the optical device box 3a from any connection position of the circuit board 4a, the flexible circuit board 5a, the ceramic 6a, the metal wire and the optical device box 3a.

For the optical module in embodiments of the present disclosure, the wire bonding circuit board 11 extends into the box 2 through the notch 4 on the optical device box 2. Thus, the circuit board 1 is in direct contact with the box 2. Further, since direct short-distance wire bonding connection is performed between the circuit board 1 and the box 2, and no other components exist between the circuit board 1 and the box 2, the circuit board 1 and the box 2 are packaged in a non-hermetic packaging manner. In some embodiments of the present disclosure, non-hermetic sealing of the box 2 is performed by coating a sealant at the joint of the circuit board 1 and the notch 4.

In some embodiments, the sealant used for non-hermetic packaging includes a resin substance. In some cases, some gas or liquid, such as a small amount of water vapor, will enter between the circuit board 1 and the box 2 from the sealant and further enter the box 2 and pollute different optical devices inside the box 2, thereby affecting electrical signal transmission between the circuit board 1 and the box 2. Therefore, to help prevent the gas or liquid from polluting different optical devices therein after entering the box 2, a desiccant 12 (shown in FIG. 5) is provided in the box 2 for absorbing the gas or liquid, such as water vapor, within the box 2.

Further, to better absorb the gas or liquid entering the box 2, the desiccant is placed at the notch 4 and the through-hole 3. In some embodiments, the desiccant is placed at an inner side wall of the box 2 to help prevent the desiccant from affecting optical transmission among different optical devices inside the box 2.

In some embodiments where the circuit board is connected with the box, when the box 2 is placed at the recess 6, the circuit board 1 is also provided with slots 8 in the recess 6, and the slots 8 both penetrate the circuit board 1, so that the wire bonding circuit board 11 extends into the box 2 through the notch 4. In some embodiments, there are two slots 8. A circuit board between the slots 8 is the wire bonding circuit board 11, as in FIG. 6. The slots 8 are arranged in such a manner that the wire bonding circuit board 11 protrudes from the circuit board recess 6, thereby facilitating extending the wire bonding circuit board 11 into the box 2 through the notch 4. In this case, the near-distance contact between the circuit board 1 and the box 2 is realized.

In some embodiments of the present disclosure, the shape of the wire bonding circuit board 11 matches the opening shape of the notch 4, so that the circuit board 1 smoothly extends into the box 2 through the notch 4. The shape of the notch 4 is not limited herein.

FIG. 7 is a schematic diagram of a detailed structure where a circuit board 1 is connected with a box 2 according to some embodiments of the present disclosure. In FIG. 7, the wire bonding circuit board 11 extends into the box 2 through the notch 4. The box 2 is internally provided with a plurality of lasers 5 arranged in a row. Each laser 5 includes a ceramic base 51 and a laser chip 52 on an upper surface of the ceramic base 51, as in FIG. 8.

A positive electrode pad 101 and a negative electrode pad 102 are on the wire bonding circuit board 11. An upper surface of the laser chip 52 is positive, and a lower surface of the laser chip 52 is negative. The upper surface of the ceramic base 51 is coated with a metal conducting layer. In addition, the upper surface of the ceramic base 51 is also provided with grooves 53 perpendicular to the laser chip 52. In some embodiments, there are two grooves 53. Since grooves 53 are on the upper surface of the ceramic base 51, the metal conducting layer is divided into two metal conducting regions, a first region between two grooves 53 is a first metal conducting region 54, and a second region on the upper surface of the ceramic base 51 is a second metal conducting region 55.

When circuits are in connection, since the laser chip 52 is located on the upper surface of the ceramic base 51, direct contact of the laser chip 52 and the ceramic base 51 causes the negative electrode of the laser chip 52 to electrically connect to the second metal conducting region 55. The positive electrode of the laser chip 52 is electrically connected to the first metal conducting region 54 through a metal wire, and the first metal conducting region 54 is electrically connected to the negative electrode pad 102 of the wire bonding circuit board 11 in a wire bonding manner. In addition, the second metal conducting region 55 is electrically connected to the positive electrode pad 101 of the wire bonding circuit board 11 in the wire bonding manner. Since the ceramic base 51 is electrically connected with the laser chip 52 and the ceramic base 51 is connected with the circuit board 1 through the metal wire 9 by wire bonding, a wire bonding connection between the wire bonding circuit board 11 and the laser 5 exists. A direct wire bonding connection also exists between the circuit board 1 and the laser 5.

Further, in some embodiments of the present disclosure, the metal wire 9 is a high-speed signal line through which a high-speed signal transmission is possible between the circuit board 1 and the laser 5. The high-speed signal line has high photoelectric signal transmission efficiency. With the arrangement of the high-speed signal line, the optical module provided by embodiments of the present disclosure is able to transmit signals with high requirements for time sequence and frequency, which enhances performance of the optical module. In addition, the length of the high-speed signal line is relatively short, compared with other arrangements, since the wire bonding circuit board 11 extends into the box 2 in embodiments of the present disclosure. As a result, the transmission distance is shorter, and the transmission efficiency is higher than other arrangements. Therefore, in embodiments of the present disclosure, the wire bonding circuit board 11 extends into the box 2 and the wire bonding circuit board 11 is electrically connected to the laser 5 by wire bonding through the high speed signal line, which allows the optical module have higher transmission efficiency and more suitable for transmission of signals using higher time sequence and frequency.

In addition, since the wire bonding circuit board 11 is electrically connected to the laser 5 through the metal wire 9 by wire bonding, electromagnetic signals are generated due to photoelectric transmission between the wire bonding circuit board 11 and the laser 5. The generated electromagnetic signal affects normal operations of different devices on the circuit board 1 and optical transmission between different optical devices inside the box a2. Therefore, in some embodiments, the electromagnetic signal generated between the wire bonding circuit board 11 and laser 5 is shielded.

In some embodiments of the present disclosure, a surface of the circuit board 1 is provided with a metal layer 10, as in FIG. 6. The metal layer 10 is in contact with the box 2, and the metal layer 10 is set to be grounded. Here, the box 2 is grounded through the metal layer 10. When an electromagnetic signal is generated between the wire bonding circuit board 11 and the laser 5, the generated electromagnetic signal is directed to the ground through the metal layer 10, thereby helping to prevent or reducing the electromagnetic signal effect on the normal operations of different devices on the circuit board 1 and inside the box 2. To facilitate the contact of the metal layer 10 and the box 2, the metal layer 10 is on a portion of the circuit board 1 which is around the sides of the circuit board recess 6.

For some embodiments where the circuit board 1 is connected with the box 2, when the width of the circuit board recess 6 is equal to the width of the box 2, the box 2 is snapped into the circuit board recess 6, thereby realizing fixed connection between the circuit board 1 and the box 2.

Since the width of the circuit board recess 6 is equal to the width of the box 2, inconsistent positioning of the circuit board 1 and the box 2 causes assembly inconvenience such as slow assembly. Therefore, in the optical module according to some embodiments of the present disclosure, there is a plurality of slide rails, wherein a first slide rail of the plurality of slide rails is on a second sidewall, a second slide rail of the plurality of slide rails is on a third sidewall of the box, the second sidewall is opposite the third sidewall, the first sidewall is different from the second sidewall and the third sidewall, and each slide rail of the plurality of slide rails is configured to allow the circuit board clamp the box. In FIG. 9, opposite outer side walls of the box 2 are provided with a slide rail 7. The slide rail 7 and the notch 4 are located on different side walls. When each of the opposite outside walls of the box 2 is provided with a slide rail 7, the circuit board 1 clamps the box 2 at the circuit board recess 6 through two slide rails 7.

Specifically, the slide rail 7 is a component for the circuit board 1 to clamp the box 2. That is, the circuit board 1 clamps the box 2 at the circuit board recess 6 through slide rails 7. In some embodiments, the circuit board 1 is a plate-structured component. In some embodiments, slide rails 7 are flat and straight suitable for causing the circuit board 1 smoothly slide into the slide rails 7. Meanwhile, the circuit board 1 is a flat plate-structured component in some embodiments. Therefore, the slide rails 7 are arranged in parallel and located on a same plane, so that the circuit board 1 clamps the box 2 at the circuit board recess 6 through the two slide rails 7.

When the circuit board 1 clamps the box 2 at the circuit board recess 6 through slide rails 7, depths of the slide rails 7 in a vertical direction are greater than or equal to a thickness of the circuit board 1 to make the circuit board 1 slide into the slide rails 7 more easily.

Further, the slide rails 7 are concaved inwardly at the outer side walls of the box 2 for ease of manufacture of the slide rails 7. Further, in some embodiments of the present disclosure, as in FIG. 9, the notch 4 and the slide rails 7 are located on the same plane, and the notch 4 is in communication with the two slide rails 7. As a result, the circuit board 1 clamps the box 2 at the circuit board recess 6 through the two slide rails 7 and the wire bonding circuit board 11 extends into the box 2 through the notch 4. The above arrangement helps with processing the box 2 and extending the wire bonding circuit board 11 into the box 2 more conveniently.

The circuit board 1 clamps the box 2 at the circuit board recess 6 through the slide rails 7, the wire bonding circuit board 11 extends into the box 2 through the notch 4, and the wire bonding circuit board 11 is electrically connected to the laser 5 by wire bonding. Then, the non-hermetic sealing of the box 2 is formed by coating a sealant at a joint of the circuit board 1 and the notch 4.

FIG. 10 is a top contour view of a circuit board and a box in an optical module structure according to some embodiments of the present disclosure. In FIG. 10, a transmitter optical subassembly 22 and a receiver optical subassembly 24 are arranged on a first end of a surface of the circuit board 1 in order, whereas the transmitter optical subassembly 22 is arranged within the box 2 in FIG. 4. One or more fingers 26 are provided on a second end of the surface of the circuit board opposite to the first end. In some embodiments, fingers 26 are gold fingers. In this way, a layout that one end of the circuit board is an optical interface and the other end of the circuit board an electrical interface is formed. The transmitter optical subassembly includes a laser chip, the receiver optical subassembly includes an optical receiver chip, and the transmitter optical subassembly and the receiver optical subassembly are aligned on one end of the circuit board. This aligned arrangement helps to generate electromagnetic interference between the transmitter optical subassembly and the receiver optical subassembly.

Some embodiments of the present disclosure provide an optical module, including a circuit board, a transmitter optical subassembly, an optical receiver chip, an arrayed waveguide grating chip, a coupler and an optical fiber. The transmitter optical subassembly is at an edge of the circuit board. The transmitter optical subassembly and the optical receiver chip are spaced apart from each other on the surface of the circuit board. The optical receiver chip is arranged between the circuit board and the arrayed waveguide grating chip. One end of the coupler is connected to the optical fiber, and the other end of the coupler is connected to the arrayed waveguide grating chip. A center of the optical fiber aligns with the center of the coupler, and the center of the arrayed waveguide grating chip does not align with the center of the coupler. The coupler protrudes from the arrayed waveguide grating chip toward the circuit board. The light from the optical fiber passes through the center of the optical fiber, the center of the coupler and a position of the arrayed waveguide grating chip lower than a center of the arrayed waveguide grating chip in sequence, and is transmitted onto a side surface of an end of the arrayed waveguide grating chip. The end of the arrayed waveguide grating chip is a side surface inclined relative to a photosensitive surface of the optical receiver chip, to reflect light to the photosensitive surface of the optical receiver chip.

In some embodiments, the transmitter optical subassembly is at the edge of the circuit board, and the transmitter optical subassembly and the optical receiver chip are spaced on the surface of the circuit board, so as to allow the optical receiver chip locate at a non-edge position of the circuit board, and the position changes of these optical devices enhance the effect of electromagnetic shielding. The center of the optical fiber aligns with the center of the coupler, and the center of the arrayed waveguide grating chip does not align with the center of the coupler. This arrangement helps with light transmission in the optical fiber, the coupler and the arrayed waveguide grating chip. In this case, the coupler protrudes from the arrayed waveguide grating chip toward the circuit board, and the circuit board has an opening for receiving the coupler, thereby realizing the positioning of the optical assemblies and the designing of the circuit board.

FIG. 11 is a schematic diagram of a structure of an optical module according to some embodiments of the present disclosure. In FIG. 11, an optical module in some embodiments of the present disclosure includes an upper shell 120, a lower shell 110 and a circuit board 200. A transmitter optical subassembly 202 and a receiver optical subassembly 204 are on the circuit board. The upper shell 120 and the lower shell 110 are combined to form a chamber for packaging the circuit board 200, the transmitter optical subassembly 202 and the receiver optical subassembly 204.

The transmitter optical subassembly includes a plurality of laser chips. Optical signals of several wavelengths emitted by the plurality of laser chips are combined into a beam of light. The beam of light is emitted out of the optical module through an emitting optical fiber 201. The beam of light enters an external communication optical fiber. In some embodiments, the transmitter optical subassembly 202 is arranged at an edge of one end of the circuit board 200 in a length direction of the circuit board 200, and one or more fingers 208 for performing electrical communication with the outside are arranged at an edge of the other end of the circuit board 200 in the length direction of the circuit board 200. In some embodiments, fingers 208 are gold fingers.

In some embodiments of the present disclosure, the laser chip in the transmitter optical subassembly and the optical receiver chip in the receiver optical subassembly are spaced in the length direction of the circuit board. That is, the transmitter optical subassembly is at the edge of the circuit board and spaced from the optical receiver chip on the surface of the circuit board. The spaced arrangement in the length direction of the circuit board increases a risk of technical difficulty in the positioning of the optical module component and the designing of the circuit board. Specifically, the optical receiver chip extends to a middle region of the circuit board from the edge of the circuit board, and all optical assemblies associated with the optical receiver chip need to move toward the middle region of the circuit board accordingly. The optical assemblies extend to the middle region of the circuit board, which increases the risk of position conflicts with original circuit designs and shape positions and so on of the circuit board.

An optical module in some embodiments of the present disclosure includes a circuit board, a transmitter optical subassembly at an edge of the circuit board, an optical receiver chip on a middle surface of the circuit board, an Arrayed Waveguide Grating (AWG) chip, a coupler and an optical fiber. One end of the coupler is connected to the optical fiber, and the other end of the coupler is connected to the arrayed waveguide grating chip. External single-beam multi-wavelength light is transmitted into the arrayed waveguide grating chip through the optical fiber and the coupler in order. The arrayed waveguide grating chip decomposes the single-beam multi-wavelength light into a plurality of paths of single-beam single-wavelength light. An end of the arrayed waveguide grating chip is of an inclined surface shape, to change the transmission directions of a plurality of paths of single-beam single-wavelength light, redirecting the light toward the surface of the optical receiver chip.

The arrayed waveguide grating chip receives a beam of light from external including optical signals with multiple wavelengths, and the arrayed waveguide grating chip decomposes the a beam of multi-wavelength light into multiple paths of single-beam single-wavelength light. The coupler connects the arrayed waveguide grating chip with the optical fiber. In some embodiments, the optical fiber is a flexible material and the arrayed waveguide grating chip is hard material. In this case, the coupler is used for a transition connection of the optical fiber and the arrayed waveguide grating chip. In some embodiments, the coupler is a capillary tube.

FIG. 12 is a section view of an optical module according to some embodiments of the present disclosure. In FIG. 12, the optical module in embodiments of the present disclosure includes a circuit board 200, an optical fiber 203, a coupler 206, an arrayed waveguide grating chip 205 and an optical receiver chip 301. The optical receiver chip 301 is on the surface of the circuit board 200. A light receiving surface/photosensitive surface of the optical receiver chip faces the top of the circuit board. A housing 302 is provided above the optical receiver chip 301 for protection. Single-path multi-wavelength light 300 is sequentially transmitted to the coupler 206 and the arrayed waveguide grating chip 205 from the optical fiber 203. When the light is transmitted in the optical fiber and the coupler, the light moves along the center of the optical fiber and the center of the coupler. When the light is transmitted in the arrayed waveguide grating chip, the light moves along a direction at a lower position of the arrayed waveguide grating chip, and the lower position is relatively close to the surface of the circuit board and the photosensitive surface of the optical receiver chip. The light is reflected at an inclined surface 303 of the end of the arrayed waveguide grating chip and redirected toward the photosensitive surface of the optical receiver chip.

In the arrayed waveguide grating chip, the light moves along a direction close to a lower surface of the chip. That is, the light does not move along a central position of the chip. This transmission location in the arrayed waveguide grating chip is different from the optical fiber and the coupler. In the optical fiber, the light moves along the center of the optical fiber. In some embodiments, the optical fiber is divided into an inner core layer and an outer wrapping layer, and the light moves along a center of the core layer. In the coupler, the light moves along a central position of the shape of the coupler.

However, in the arrayed waveguide grating chip, a thickness of a substrate of the chip is far greater than a thickness of a grating layer due to a chip growing process. When the light passes through the grating layer, a position on the arrayed waveguide grating chip which is used for receiving the light is at a lower side of the whole arrayed waveguide grating chip rather than at the central position. After product assembly is completed, the lower position of the arrayed waveguide grating chip is closer to the surface of the circuit board and the surface of the optical receiver chip.

The center of the coupler and the lower position of the arrayed waveguide grating chip are located at a same axis since the light moves along the center of the coupler and the lower position of the arrayed waveguide grating chip. In this case, the contour of the coupler protrudes toward the circuit board relative to a contour of the arrayed waveguide grating chip so that an opening is disposed on the circuit board to avoid the protruding part of the coupler.

Both the coupler and the arrayed waveguide grating chip are relatively precise optical devices. Due to processing limitations, thinning of the arrayed waveguide grating chip and the coupler is difficult.

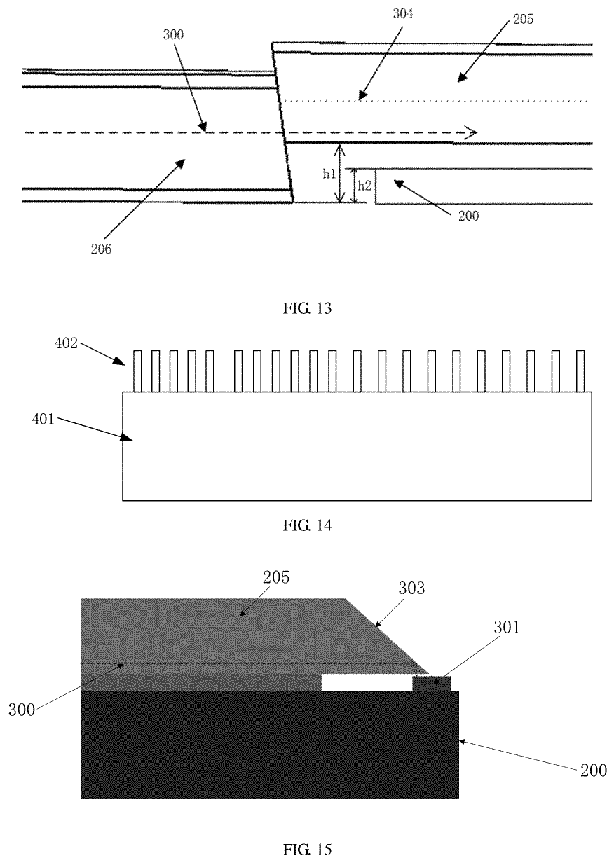

FIG. 13 is a partial schematic diagram of the optical module according to some embodiments of the present disclosure. In FIG. 13, the optical module includes a circuit board 200, a coupler 206 and an arrayed waveguide grating chip 205. When the light 300 passes through the center of the coupler 206, the light 300 passes along a position close to the surface of the coupler 206, compared with the center 304 of the arrayed waveguide grating chip 205. In FIG. 13, a position where the light 300 passed is lower than the center 304 or deflected to a side. Because of size limitations of the coupler and the arrayed waveguide grating chip, a height that the coupler protrudes toward the circuit board relative to the arrayed waveguide grating chip is h1. That is, the coupler protrudes from the arrayed waveguide grating chip toward the circuit board. A height that height h1 protrudes toward a lower surface of the circuit board relative to the circuit board 200 is h2, and the circuit board 200 forms a gap, such as a space 207 in FIG. 11 and FIG. 12 to avoid the protruding part h2. In some embodiments, this gap is as an opening on the circuit board. In some embodiments, the opening is in the middle of the circuit board, or at an edge of an irregularly-shaped circuit board. In some embodiments, the opening is a through-hole on the circuit board, or a recess on the circuit board.

The transmitter optical subassembly is at an edge of the circuit board. When the opening is at the edge of the circuit board, the edge of the circuit board is not flat and orderly, and the opening is concaved toward the inside of the circuit board relative to the transmitter optical subassembly. The circuit board is in an irregular shape rather than a square. Here, both the transmitter optical subassembly and the receiver optical subassembly are at the edge of the circuit board, but not at the same edge.

In some embodiments, when the opening is in the middle of the circuit board, the circuit board around the opening includes a circuit or a wire collecting apparatus for winding the optical fiber.

In FIG. 13, a joining surface on the coupler which joins with the arrayed waveguide grating chip is a slope, and a joining surface on an arrayed waveguide grating which joins with the coupler is a slope. In some embodiments, the slope changes a light reflection direction and helps to prevent light passing through the joining surface from being reflected back into the coupler.

A joining surface on the coupler which joins with the optical fiber is a slope, and a joining surface on the optical fiber which joins with the coupler is a slope. In some embodiments, the slope changes a light reflection direction and helps to prevent light passing through the joining surface from being reflected back into the optical fiber.

FIG. 14 is a schematic diagram of a structure of an arrayed waveguide grating chip according to some embodiments of the present disclosure. In FIG. 14, a chip is manufactured based on growing and etching processes, and a substrate is a basis for chip growth and etching. Therefore, a thickness of the substrate 401 of the chip is relatively large, while a thickness of a grating layer 402 of the chip is relatively small. As a whole, when the light passes through the grating layer of the chip, the light does not pass through the central position of the arrayed waveguide grating chip. In order to make a light emitting position of the arrayed waveguide grating chip as close to the surface of the optical receiver chip as possible, the arrayed waveguide grating chip is placed upside down relative to the position in FIG. 14, such that the grating layer of the arrayed waveguide grating chip faces the circuit board, the substrate layer is away from the circuit board, and the substrate of the arrayed waveguide grating is farther away from the circuit board relative to the grating layer. In FIG. 12 and FIG. 13, in an assembled optical module structure, the light is transmitted along a lower surface of the arrayed waveguide grating.

FIG. 15 is a partial schematic diagram of the optical module according to some embodiments of the present disclosure. In FIG. 15, the optical module includes a circuit board 200, an arrayed waveguide grating chip 205 and an optical receiver chip 301. A grating layer of the arrayed waveguide grating chip 205 is relatively close to the optical receiver chip 301, so as to cause the light 300 to move along a lower layer in the arrayed waveguide grating chip, reflected by an end surface 303, and then to be transmitted toward a surface of the circuit board 200, and then to a surface/photosensitive surface of the optical receiver chip 301.

In light of the contents disclosed in the specification of the present disclosure, those skilled in the art would understand that embodiments are able to be modified. The present disclosure is intended to include any variations, uses and adaptive changes of the present disclosure. Those variations, uses and adaptive changes that fall within the general principle of the present disclosure and include common knowledge or conventional technical means in the art not disclosed in the present disclosure. The specification and examples herein are intended to be illustrative only, and the scope and spirit of the present disclosure are indicated by the following claims of the present disclosure.

One of ordinary skill in the art would understand that the terms such as “first” and “second” used herein are merely intended to distinguish one entity or operation from another entity or operation rather than to require or imply any such relation or order between these entities or operations. The present disclosure is not limited to the precise structures described above and shown in the accompanying drawings and may be modified or changed without departing from the scope of the present disclosure. The scope of the present disclosure is limited only by the appended claims.

1. An optical module, comprising:
an upper shell;
a lower shell, wherein the upper shell and the lower shell define a chamber;
a box within the chamber, wherein the box is configured to receive one or more optical devices, and a first sidewall of the box includes a first notch; and
a circuit board within the chamber, wherein the circuit board extends into the box through the first notch, and the circuit board is configured to electrically connect with an optical device of the one or more optical devices with a bonded wire.

2. The optical module according to claim 1, further comprising a sealant on a joint of the first notch and the circuit board for sealing the box.

3. The optical module according to claim 1, further comprising a second notch on an end of the circuit board, wherein the box is in the second notch.

4. The optical module according to claim 3, further comprising a plurality of slide rails, wherein a first slide rail of the plurality of slide rails is on a second sidewall, a second slide rail of the plurality of slide rails is on a third sidewall of the box, the second sidewall is opposite the third sidewall, the first sidewall is different from the second sidewall and the third sidewall, and each slide rail of the plurality of slide rails is configured to allow the circuit board clamp the box.

5. The optical module according to claim 3, further comprising a metal layer on the circuit board, wherein the metal layer is around one or more sides of the second notch, the metal layer is in contact with the box, and the metal layer is configured to be grounded.

6. The optical module according to claim 1, further comprising a desiccant in the box.

7. The optical module according to claim 1, wherein the bonded wire is configured to transmit a high-speed signal.

8. The optical module according to claim 4, wherein each slide rail of the plurality of slide rails is concaved toward an outer side of the box.

9. The optical module according to claim 4, wherein a depth of each slide rail of the plurality of slide rails is greater than or equal to a thickness of the circuit board.

10. The optical module according to claim 4, wherein the first notch is on a same plane as each slide rail of the plurality of slide rails, and the first notch is in communication with at least one slide rail of the plurality of slide rails.

11. The optical module according to claim 4, further comprising:
an arrayed waveguide grating chip;
an optical receiver chip, wherein the optical receiver chip is between the circuit board and the arrayed waveguide grating chip, and an end of the arrayed waveguide grating chip is an end surface inclined relative to a photosensitive surface of the optical receiver chip to reflect light to the photosensitive surface;
a coupler, wherein a first end of the coupler is connected to the optical fiber, and a second end of the coupler is connected to the arrayed waveguide grating chip, and the coupler protrudes from the arrayed waveguide grating chip toward the circuit board, and the circuit board has an opening for receiving the coupler; and
an optical fiber, wherein a center of the coupler is aligned with a center of the optical fiber and offset from a center of the arrayed waveguide grating chip,
wherein the optical device comprises a transmitter optical subassembly at an edge of the circuit board, and the transmitter optical subassembly is spaced apart from the optical receiver chip on a surface of the circuit board.

12. The optical module according to claim 11, wherein the opening is located at a middle position of the circuit board.

13. The optical module according to claim 11, wherein the opening is concaved toward an inside of circuit board relative to the transmitter optical subassembly.

14. The optical module according to claim 11, wherein an end surface on the coupler which is in contact with the arrayed waveguide grating chip is an inclined surface.

15. The optical module according to claim 11, wherein the arrayed waveguide grating chip comprises a substrate layer and a grating layer, and the substrate layer is farther away from the circuit board than the grating layer.

16. An optical module, comprising:
a box, wherein a first sidewall of the box comprises a first notch, a second sidewall of the box comprises a through hole, the second sidewall is opposite the first sidewall, and the through hole is configured to receive an optical fiber;
a circuit board, wherein a portion of the circuit board extends into the box through the first notch, and a second portion of the circuit board protrudes from the box; and
an optical device within the box, wherein the optical device is spaced from the circuit board, and the optical device is electrically connected to the circuit board.
